(19) United States
(12) Patent Application Publication
(10) Pub. No.: US 2010/0325949 A1
(43) Pub. Date: Dec. 30, 2010

(54) SUPPORT APPARATUS FOR CLIMBING PLANTS

(76) Inventor: Edward Scott Carlson, Delmont, PA (US)

Correspondence Address: James Ray & Associates, 2640 Pitcairn Road, Monroeville, PA, 15146, US

(21) Appl. No.: 12/667,406

(22) PCT Filed: Jul. 3, 2008
(86) PCT No.: PCT/US08/08250

§ 371 Date: Dec. 31, 2009

Related U.S. Application Data
(60) Provisional application No. 60/958,304, filed on Jul. 3, 2007.

(51) Int. Cl. A01G 17/06

(52) U.S. Cl. 47/45

(57) ABSTRACT

A decorative apparatus engageable with a predetermined structure for supporting a vine like plant. The apparatus comprises a support member having a first predetermined shape, and each of a predetermined rigidity and a predetermined strength which are at least sufficient to support such vine like plant. The support member is engageable with and securable to such predetermined structure, such support member is disposed in one of a substantially horizontal plane, an arcuate plane and at a predetermined angular plane. There is at least one elongated member having a predetermined length engageable with and suspended from such support member for allowing such vine like plant to intertwine therewith.

### CROSS REFERENCE TO RELATED APPLICATIONS

This application is closely related to and claims benefit from U.S. Provisional Application Ser. No. 60,958,304 filed Jul. 3, 2007.

### FIELD OF THE INVENTION

The present invention relates, in general, to clinging, twining, and winding vines and climbing plants, and, more particularly, the present invention relates to an apparatus for supporting such vines and climbing plants so as to cause them to grow in a prescribed manor, and, that has been designed for installation in various locations around a home, business, and in a landscape.

### BACKGROUND OF THE INVENTION

Vines are some of the most versatile plants in a landscape and support structures, such as trellises and arbors, are commonly in use. Presently available trellises are typically installed in the ground or parallel to a wall.

Ground supported trellises are the most common and many designs exist, however, it isn't always obvious as to where to place trellises in a landscape, further, vines typically have to be planted adjacent to a trellis. Installation of a ground supported trellis can be time consuming and cumbersome because holes have to be dug in the ground and heavier trellises commonly require additional support sleeves or concrete in order to keep them erect. If rock is encountered while digging a hole the rock either has to be removed or the trellis has to be placed in an alternate less desirable position. If no support sleeve or concrete is used then the ground supported trellis will tend to lean or collapse when a plant becomes top heavy. In addition, if wood trellises are installed directly in the ground the legs can rot requiring a new trellis.

Parallel wall mount designs can only be installed on flat vertical surfaces which limit available sunlight to foliage, vegetables, fruits, and flowers to only the outwardly facing side.

Many attempts are made by gardeners to grow vines around their home on lamp posts, mail boxes, decks, fences and other such structures. Existing trellises are either laid against these structures and/or twine, tape, chicken wire, mesh and other such materials are used in order to provide support for vines. In any case the attempts to create a home made support typically results in an unaesthetic ineffective structure.

Accordingly there exists a need for a support apparatus that is designed for specific locations, such as a lamp post or mailbox for commonly used locations and a need also exists for an apparatus that is non-ground supported that can be installed generally above a plant that increases space for root structure and also provides a generally vertical path to the trellis, as opposed to starting the plant at an angle and then redirecting vertically, such as around a base leg. The present invention promotes healthy growth. An apparatus is also needed that does not require digging or additional ground support that can easily and quickly be installed. In addition the trellises can be installed perpendicular to a structure, as opposed to parallel, creating more aesthetic presentation into a landscape bed and increasing sunlight exposure to the foliage which also promotes healthy growth.

### SUMMARY OF THE INVENTION

In a first aspect the present invention provides a decorative apparatus engageable with a predetermined structure for supporting vines and climbing plants. The apparatus comprises a support member having a first predetermined shape, and each of a predetermined rigidity and a predetermined strength which are at least sufficient to support such vines and climbing plants. The support member is engageable with and securable to such predetermined structure, such support member is disposed in one of a substantially horizontal plane, an arcuate plane and at a predetermined angular plane. There is at least one elongated member having a predetermined length engageable with and suspended from such support member for allowing such vines and climbing plants to intertwine therewith.

In a second aspect the present invention provides a decorative apparatus for supporting a vines and climbing plants. The apparatus comprises a generally vertically disposed supporting structure extending above ground level for a predetermined distance and having each of a predetermined rigidity and a predetermined strength which are at least sufficient to support such vines or climbing plants. Such supporting structure is engageable with and securable to a predetermined structure. A support member is engageable with and attached to the vertically disposed supporting structure, such support member having a first predetermined shape, and each of a predetermined rigidity and a predetermined strength which are at least sufficient to support such vines or climbing plants. The support member is disposed in one of a substantially horizontal plane, an arcuate plane and at a predetermined angular plane. There is at least one elongated member having a predetermined length engageable with and suspended from such support member for allowing such vines or climbing plants to intertwine therewith.

### OBJECTS OF THE INVENTION

It is, therefore, one of the primary objects of the present invention to provide an apparatus for supporting vines and climbing plants.

Another object of the present invention is to provide an apparatus for supporting vines and climbing plants that can be used with a lamp post, mail box, a fence, a side of a building and other structures.

Yet another object of the present invention is to provide an apparatus for supporting vines and climbing plants that is attractive.

Still another object of the present invention is to provide and apparatus for supporting vines and climbing plants that is relatively inexpensive.

Another object of the present invention is to provide an apparatus for supporting vines and climbing plants that includes a plurality of string or rod members that are weighted and separated so as to maintain their position.

Yet another object of the present invention is to provide an apparatus for supporting vines and climbing plants that can packaged into a relatively compact box.

Still another object of the present invention is to provide an apparatus for supporting vines and climbing plants that is easy to install.

Another object of the present invention is to provide an apparatus for supporting vines and climbing plants that has a design that is adjustable so that it can be positioned differently or in different locations.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a perspective view of an apparatus showing the support member with such elongated members attached thereto according to an embodiment of the invention.

FIG. 2A is a perspective view of the apparatus attached to a post and having a spacer bar on the elongated members according to an alternate embodiment.

FIG. 2B is a perspective view of an integral head member which includes an elongated member and the spacer bar that are shown in FIG. 2A.

FIG. 3 is a perspective view of the apparatus showing an intermediate spacer bar arrangement.

FIG. 4 is a perspective view of the apparatus showing two different spacer bar arrangements.

FIG. 5A is a perspective view of a cord lock arrangement for securing such elongated member to a support member.

FIG. 5B is a perspective view of a push nut arrangement for securing such elongated member to such support member.

FIG. 6A is side view of the apparatus showing a different arrangement for attaching such apparatus to a top fence and deck rail wherein such attachment means is adjustable.

FIG. 6B is an enlarged view of the attachment means shown in FIG. 6A and a means for securing such.

FIG. 7 is a side view of the apparatus showing a different arrangement for such elongated member and showing stakes for securing such elongated members to the ground according to an alternate embodiment of the invention.

FIG. 8 is a side view showing a sleeve member and yet another different arrangement of such elongated member and a different means of securing such elongated member to the support member.

FIG. 9 is a perspective view showing yet another means of securing such support member to a post member wherein the support member is tightened on to the post with nuts and bolts.

FIG. 10 shows several perspective views of a support member that is shaped as a half circle for attachment to such predetermined structure.

FIG. 11 is side view of a different arrangement for the elongated members wherein such elongated members extend both downward and upward from the support member.

FIG. 12 is a perspective view of a different arrangement wherein the support member attached to a predetermined structure is in the form of a shelf for holding some object, such as a potted plant.

FIG. 13 is a perspective view of a support member in the form of an angle iron that is secured to an inside corner of a predetermined structure.

FIG. 14A is a perspective view of the supporting structure for attachment to such predetermined structure having the support member and elongated member attached thereto.

FIG. 14B is a perspective view of the apparatus shown in FIG. 14A showing the apparatus from a different angle.

FIG. 15 is a perspective view showing a different means for attaching such support member to a fence post wherein the support member is attached to the post by means of a post cap.

FIG. 16 is a perspective view of a combination support member wherein such support member has elongated members attached thereto and also has a bird feeder attached thereto.

FIG. 17 is a perspective view of another combination support member wherein such support member has a threaded attachment means with a predetermined structure and which has elongated members attached thereto and also has a garden flag attached thereto.

FIG. 18 is a perspective view of the apparatus showing a different type of spacing member.

FIG. 19 is a perspective view of an apparatus that has two separate support members with a connecting means for connecting such two support members.

FIG. 20 is a perspective view showing a hanging basket being used as a support member and having a circular spacing member.

FIG. 21 is a perspective view of the apparatus shown in FIG. 20 without having a spacing member.

FIG. 22 is a side view of the apparatus wherein the support member is self supporting.

FIG. 23 is a perspective view of another means of securing such elongated member to the support member by means of a compression fit.

FIG. 24 is a perspective view of still another alternate means of securing such elongated member to the support member.

FIG. 25 is a perspective view of the apparatus wherein the support member is attached to a mailbox post and has a fan like mount above the support member for having wining plants form a back drop for the mailbox.

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, engageable with a predetermined structure 2 for supporting vines and climbing plants. The apparatus 10 comprises a support member 4 having a first predetermined shape, and each of a predetermined rigidity and a predetermined strength which are at least sufficient to support such vines and climbing plants. The support member 4 is engageable with and securable to such predetermined structure 2, such support member 4 is disposed in one of a substantially horizontal plane, an arcuate plane and at a predetermined angular plane. There is at least one elongated member 6 having a predetermined length engageable with and suspended from such support member 4 for allowing such vines and climbing plants to intertwine therewith.

The apparatus 10 further includes a first means, generally designated 20 that is engageable with and adjacent a first end 8 of the elongated member 6 and such support member 4 for retaining the at least one elongated member 6 in engagement with the support member 4.

The apparatus 10 further includes a second means, generally designated 30, that is engageable with a second end 12 of the elongated member 6 for maintaining the at least one elongated member 6 in a substantially vertically disposed position.

Such support member 4 is formed of one of plastic, wood and metal and combinations thereof and such at least one elongated member 6 is formed of one of wire, string, tubing, rods, wood, metal, twine, plastic, rope and combinations thereof. It is within the scope of the invention that such string or wire could be knotted at various points along its length to provide for gripping engagement with such vines or climbing plants.

Such tubing or rods can be threaded, telescoping, fold up (similar to a carpenter's ruler), and even have projections on either side for engagement with such vining plants. Such wire can be connected by sections engageable with each other by means of hooks, eyes and eyelets. It should be noted that several of the variations of such elongated member such as the rods or tubing that are telescoping, threaded or fold up are strong enough that there is no need for a weighted member to keep them straight nor is there a need of a spacing member. These types can also be used where the elongated members 6 extend above the support member 4 where a user may wish to have an extra tall vining plant. Such an arrangement is seen in FIG. 11.

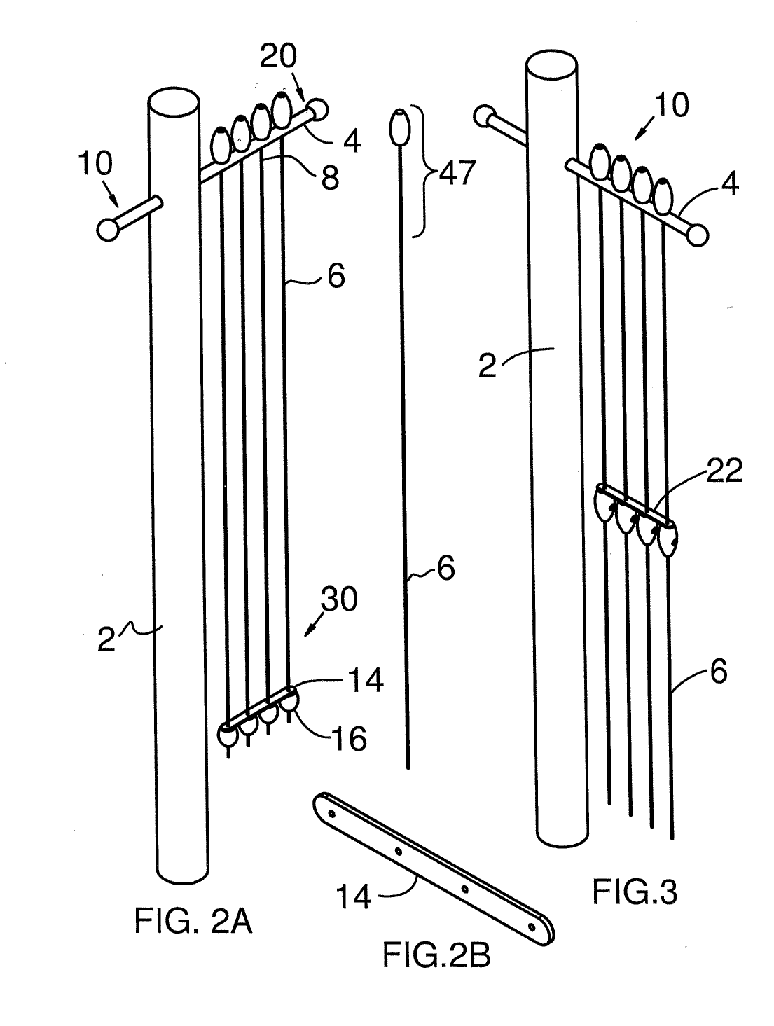

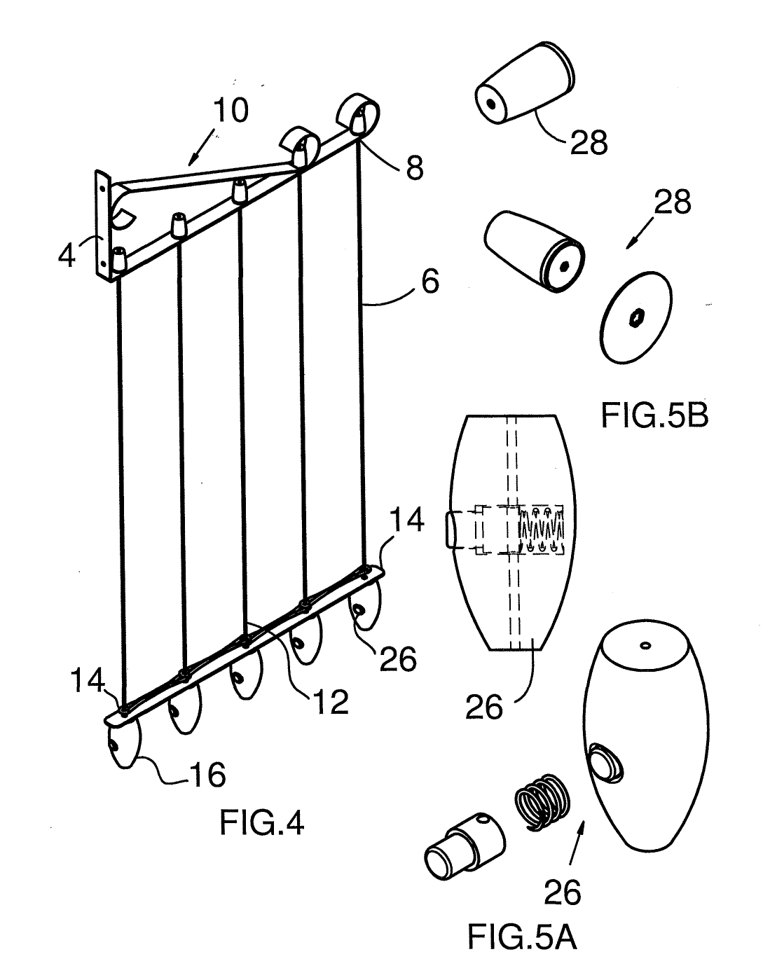

Such apparatus includes at least one elongated member 6. In some configurations there are four elongated members 6, while others may have five or even more elongated members 6. The apparatus 10 having a plurality of elongated members 6 may further include a spacing member 14 that is disposed on a second end 12 of the plurality of elongated members 6 for keeping a predetermined space between individual elongated members 6 of the plurality of elongated members 6. Such apparatus may further include at least one intermediate spacing bar 22, that is disposed somewhere intermediate the support member 4 and the second end of the elongated members 6. Some examples of spacing bars 14,22 are seen in FIG. 2A, 3, 4 or 6A.

The elongated member 6 further includes a weighted member 16 disposed on a second end 12 thereof for keeping the elongated members 6 in a vertical position. Item 16 is described as a weighted member; however, the members labeled 16 may not all be weighted members since in some embodiments such spacing member 14 may be weighted and thus there is no need to have the weighted members be weighted but such members 16 are still needed to secure the second end 12 of such elongated members 6.

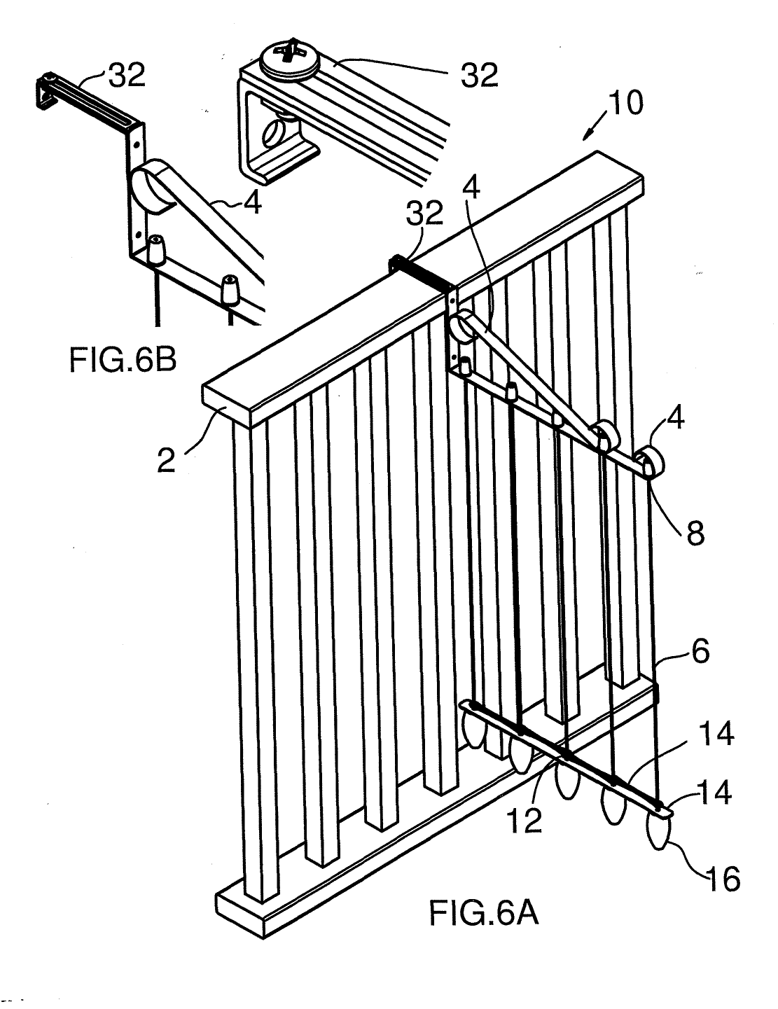

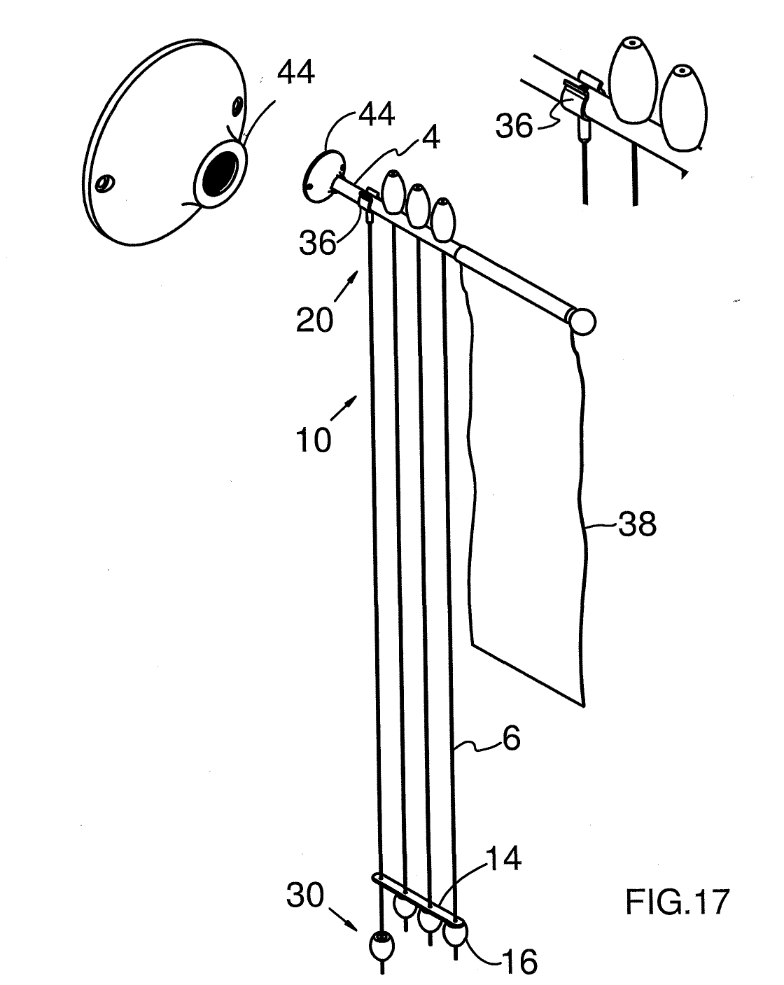

Such first means 20 (or such second means 30) for retaining the elongated member 6 in engagement with the support member 4 includes at least one of a push nut, adhesive, knot, cord lock, lock washer, threaded connection, compression fit, integral head member, and a clip. FIG. 5A shows a cord lock 26 assembled and disassembled while FIG. 5B shows a push nut 28 (also called a lock washer) while clip member 36 is seen in FIG. 17.

Such first means 20 may include an integral head member 47 as seen in FIG. 2B. In this embodiment the elongated member 6 and the head member are formed as a single unit 47 wherein the elongated member 6 is fed down through the support member 4 with the head member on top of the support member 4 and the bottom of the elongated member 6 engageable with such second means 30.

Such integral head member 47 could also be an integral foot member just by reversing the mode and feeding the elongated member 6 up through the spacing member 14 and/or up through the support member 4 where it would be engaged and held in place by such first means 20.

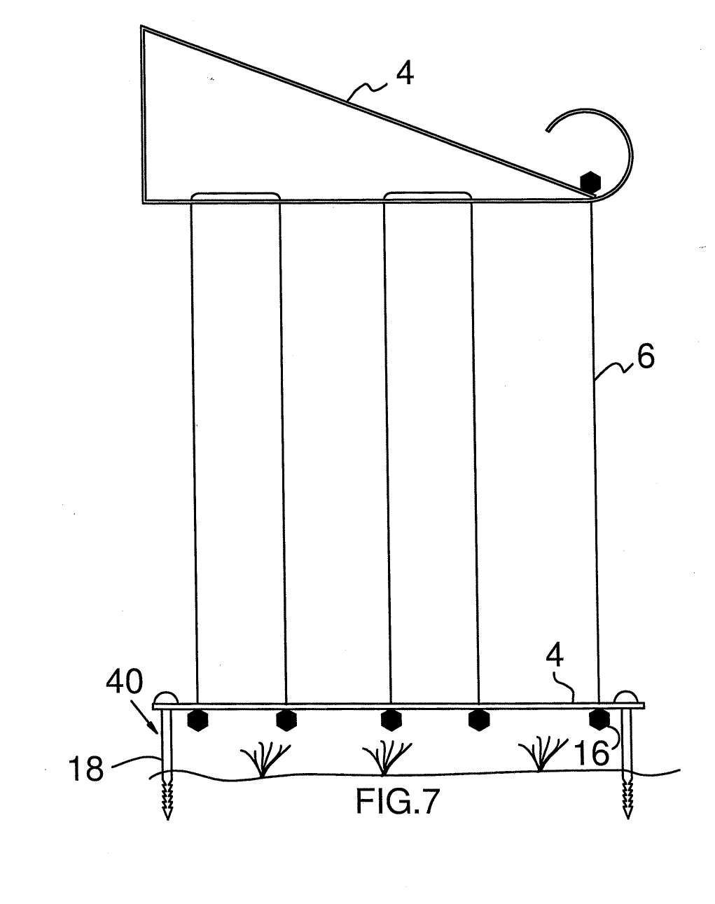

It is also within the scope of the invention that such apparatus 10 further includes a third means, generally designated 40 for securing the spacing member 14 to the ground, as seen in FIG. 7, so as to prevent such elongated members 6 from moving in windy conditions. Although there are several means for securing such elongated member to the ground it is presently preferred that such third means 40 for securing the spacing member 14 to the ground includes a stake 18.

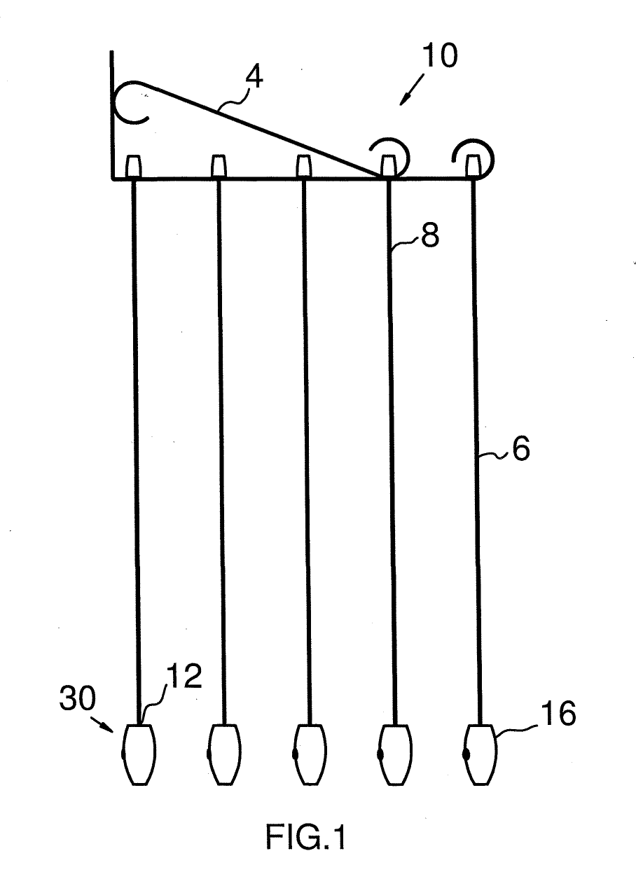

Such support member 4 can be attached to a predetermined structure by a variety of means. The support member shown in FIG. 1 could be attached to any relatively flat vertical surface such as a pole, a post or a wall by means of screws. FIGS. 6A, 15 and 22 show variations in which the support member 4 is connected to the top of a fence post, fence rail or deck rail. The support member 4 is secured to the top of the rail by an adjustable bracket 32 in FIG. 6A, however, it could also be secured by means of a thumb screw.

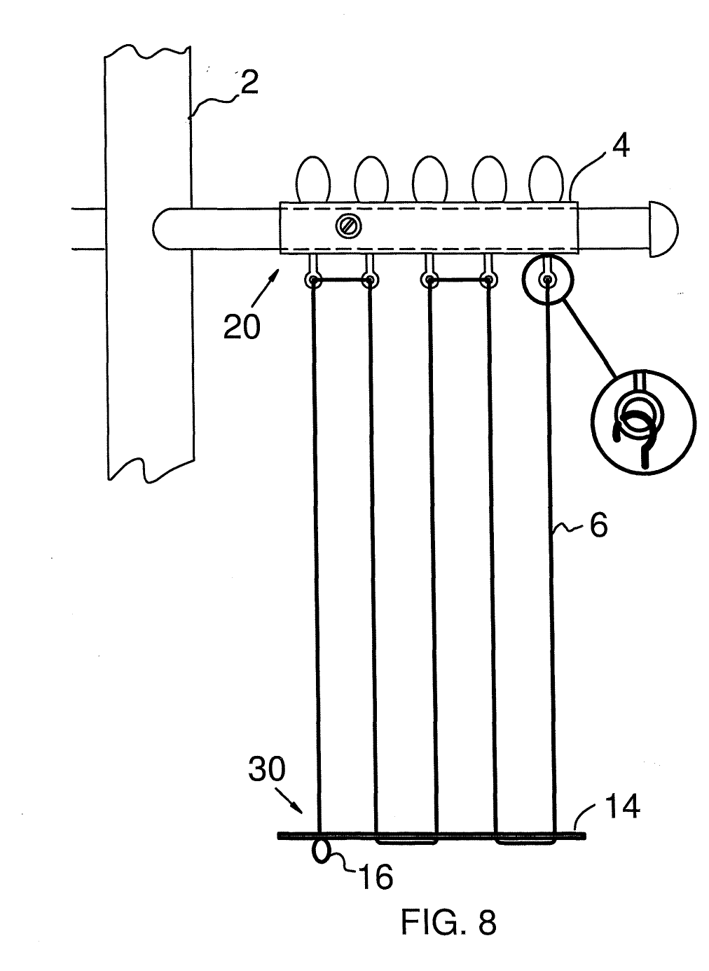

FIG. 8 shows a variation wherein such support member 4 is connected to a rod from a lamp post with a sleeve attachment 4. Also FIG. 8 shows a different variation in the use of the elongated members 6 wherein the members are continuous for two locations. The elongated member could be threaded through such support member 4 and such spacing member 14 wherein all of the elongated members 6 would be one continuous string or wire.

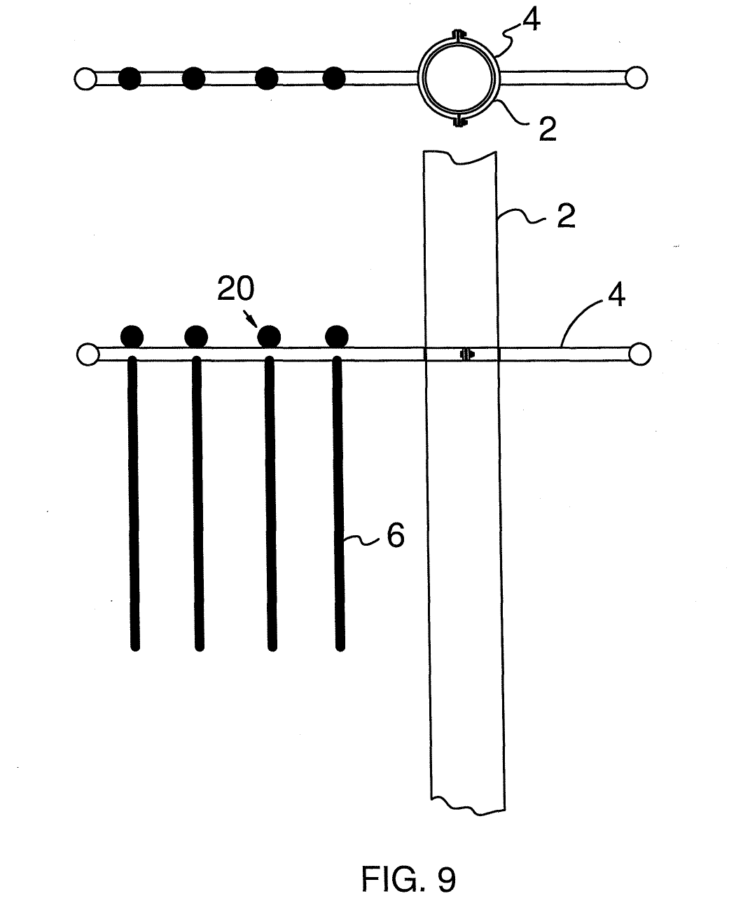

FIG. 9 shows a support member 4 that connects to a lamp post pole by having two semicircle portions wherein each half engages half of a pole and the two semicircular portions are secured by a nut and bolt to firmly secure the two halves together. FIG. 9 also shows the embodiment wherein the support member 4 extends on each side of the predetermined structure 2.

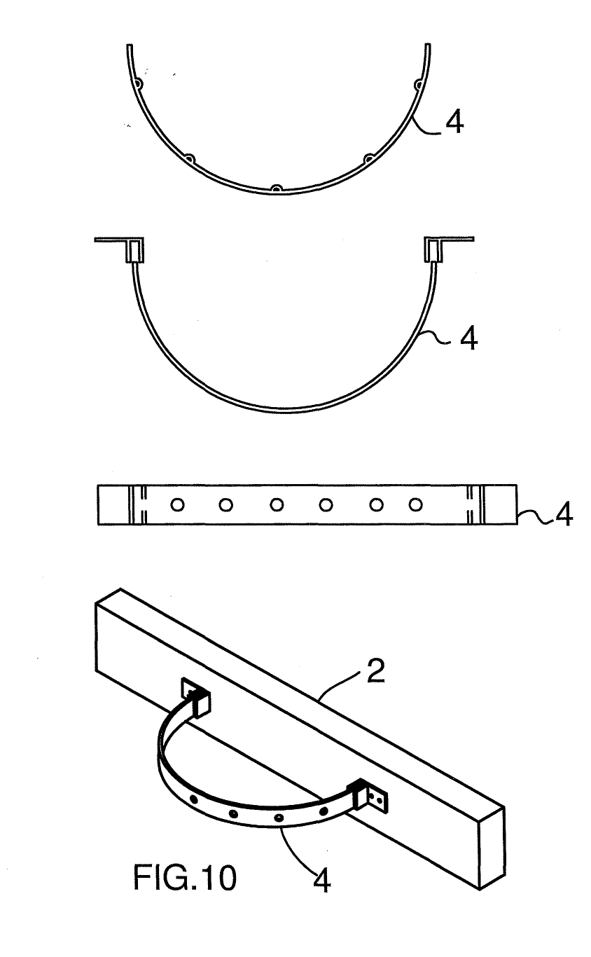

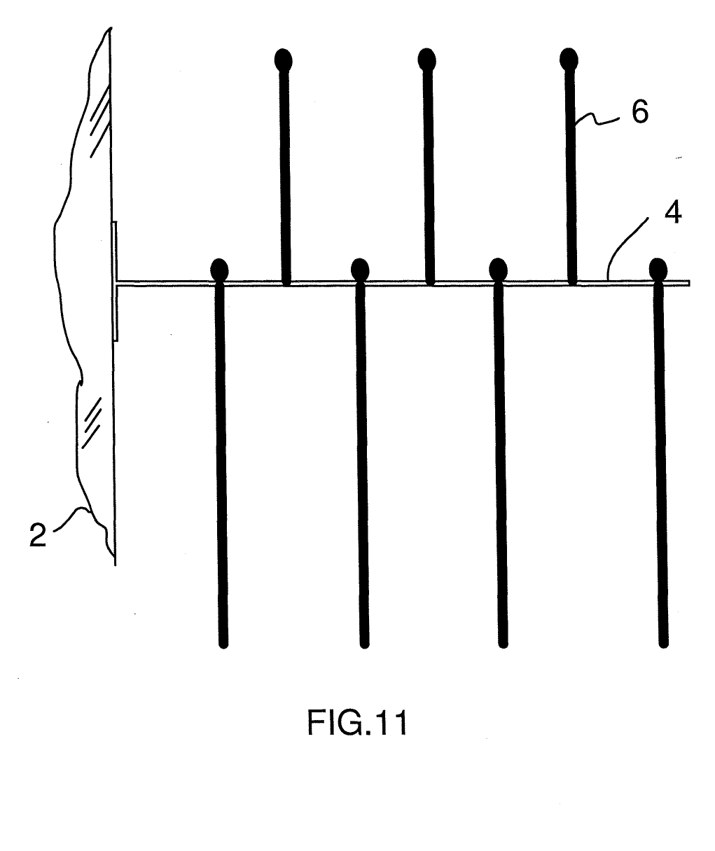

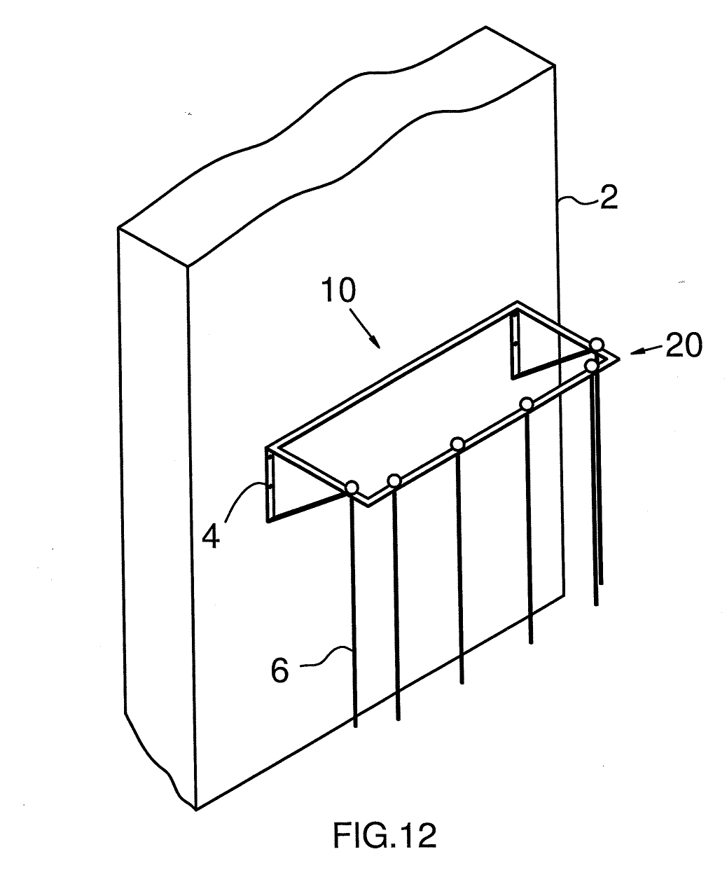

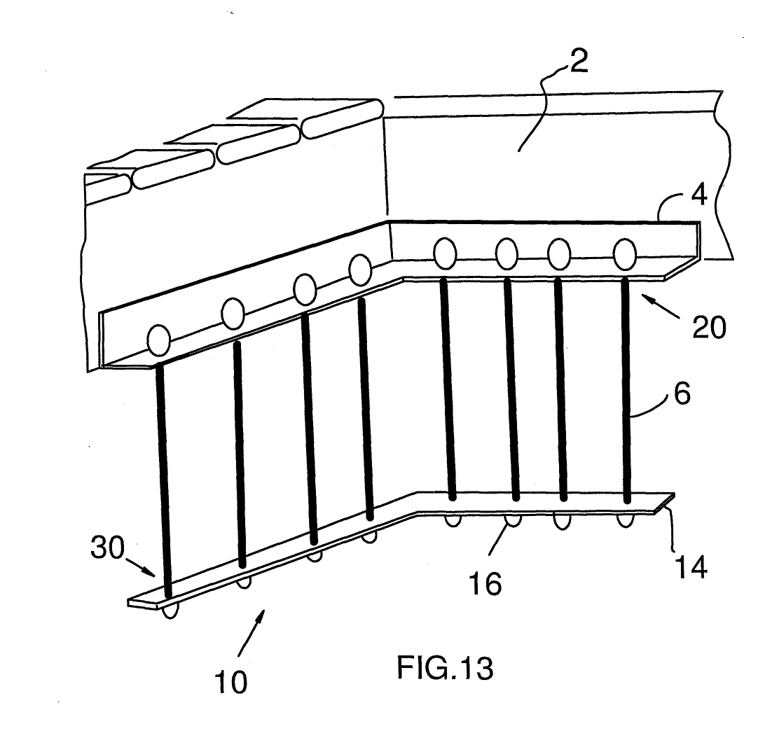

FIG. 10 shows the embodiment of the support member 4 that is in the shape of a semicircle that can be attached to any vertical surface by means of screws. FIG. 11 shows an embodiment where the support member 4 has elongated members 6 that extend downward while other elongated members 6 extend upward. It should be noted, as mentioned previously, that such elongated members 6 that extend upward have to be self supporting, that is, they must be of the tubing or rod type of elongated member 6. FIG. 12 shows a support member 4 that has a flat vertical portion that attaches to a flat vertical predetermined structure 2 and such support member 4 has a flat horizontal portion that can be used a shelf for possibly holding a potted plant, planter or other similar items. FIG. 13 shows a support member 4 in the shape of an angle iron that is used on an inside corner of such predetermined structure 2. However, such a support member 4 of an angle iron could be used on a straight wall section also.

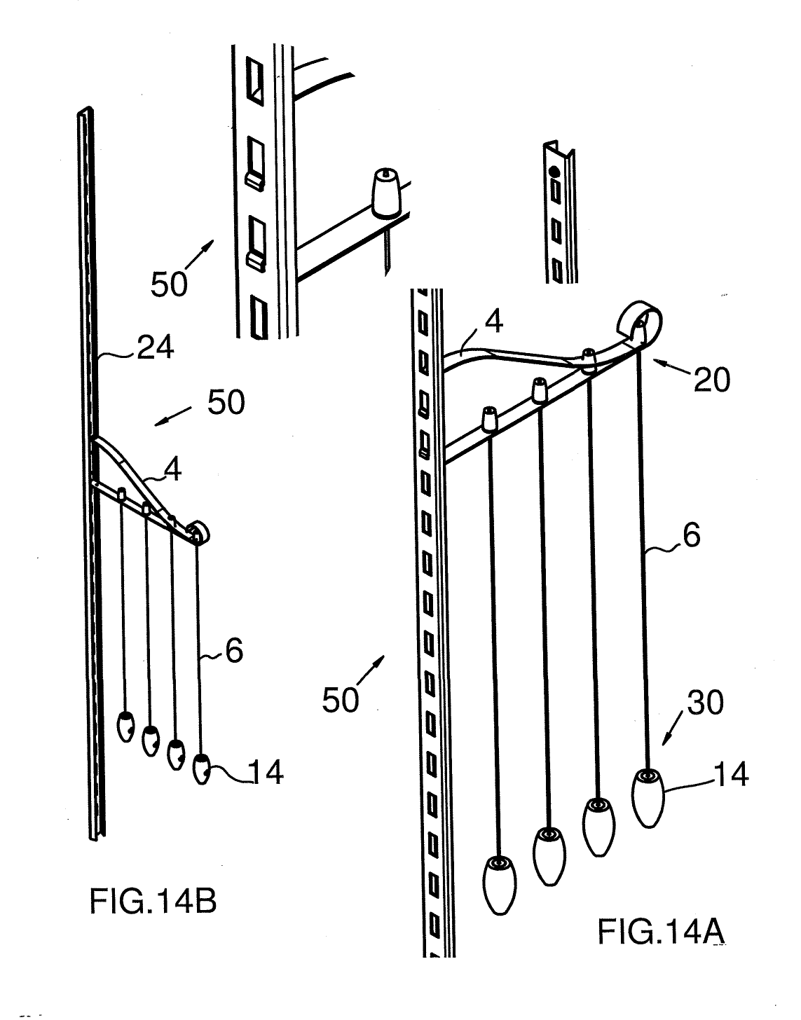

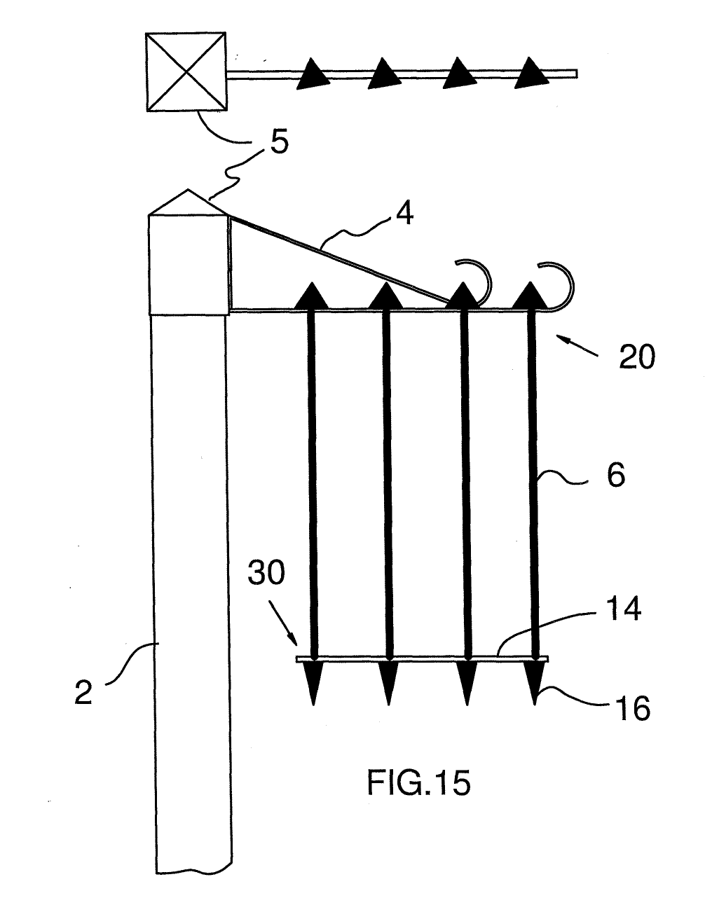

FIGS. 14A and 14B show an embodiment wherein a supporting structure 50 is shown for attachment to a predetermined structure 2. This Figure shows the supporting structure 50 is a bracket 24 that permits the support member 4 to be able to be adjusted to different positions. Thus, the support member 4 can be attached at various positions on the bracket 24 (supporting structure 50).

FIG. 15 shows a support member 4 that has cap member 5 formed on an end of the support member 4 for engagement with the top of a fence post wherein there is no need of having screws or a means of securing such support member 4 to the predetermined structure 2.

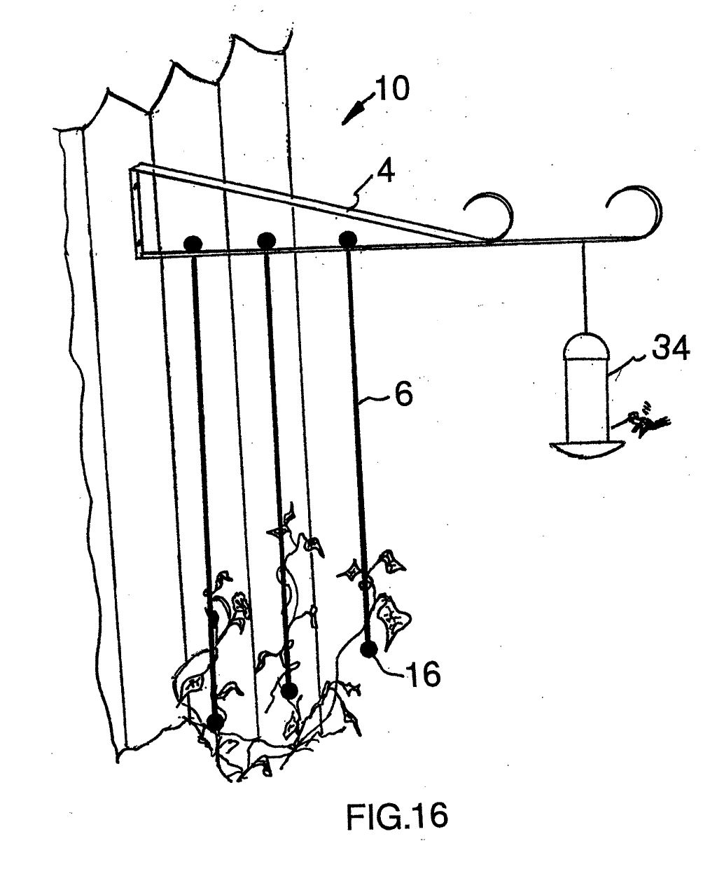

FIGS. 16 and 17 show two different combination apparatuses 10 wherein such support member 4 not only has elongated members 6 attached thereto for intertwining with vines and climbing plants but also provides for an extension on such support member 4 where a user may attach an item such as a bird feeder 34 or may attach a garden flag 38, or other similar items. Such apparatus 10 could also have a hanging basket (not shown) in place of the bird feeder or flag.

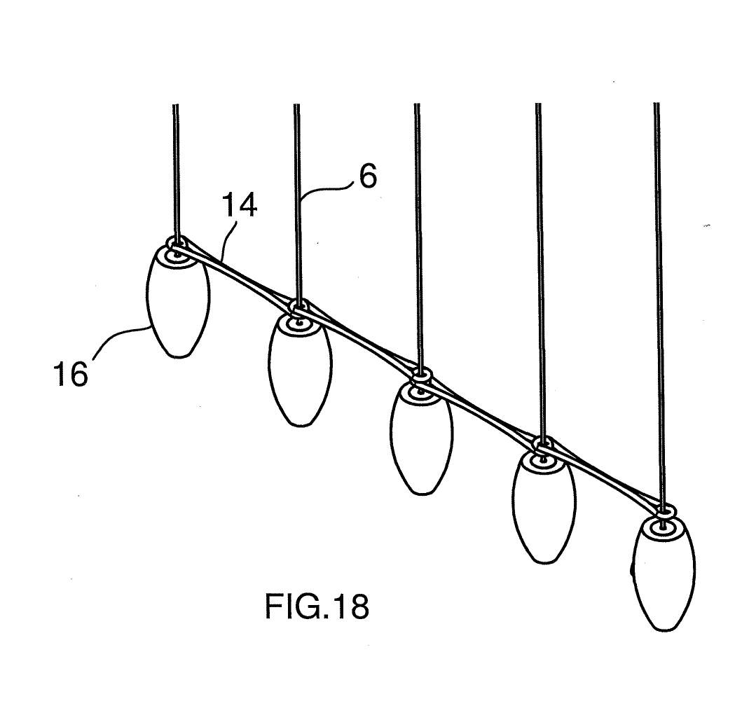

FIG. 18 shows an apparatus 10 wherein a different spacing arrangement 14 is seen.

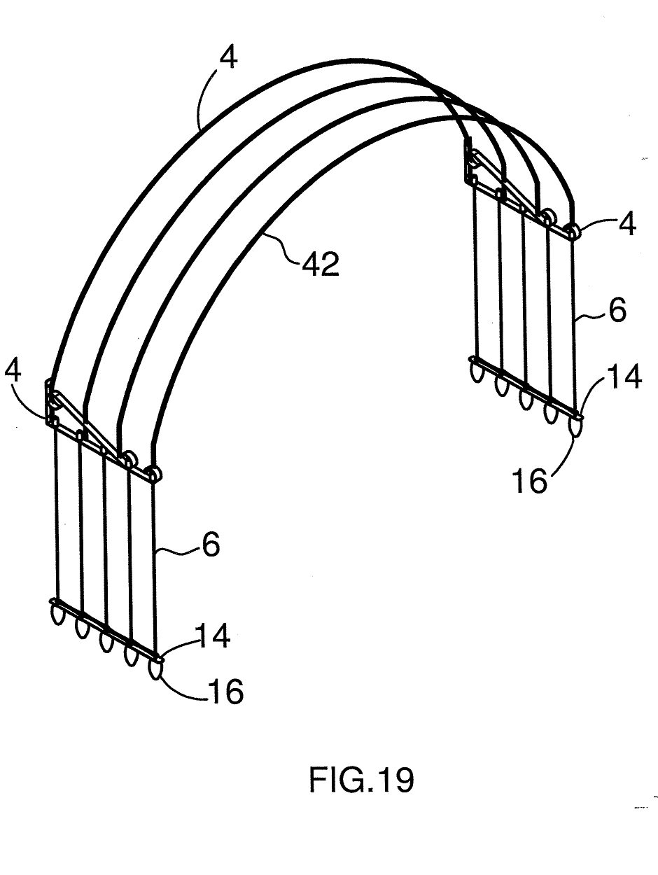

FIG. 19 shows two different support members 4 that are connected together by a connecting member(s) 42. This arrangement provides the user with the ability to have the vining plant grow so as to form an arch. Such connecting member(s) 42 could also be in the form of a square, rectangle or other various shapes. This arrangement could also include three or even more support members.

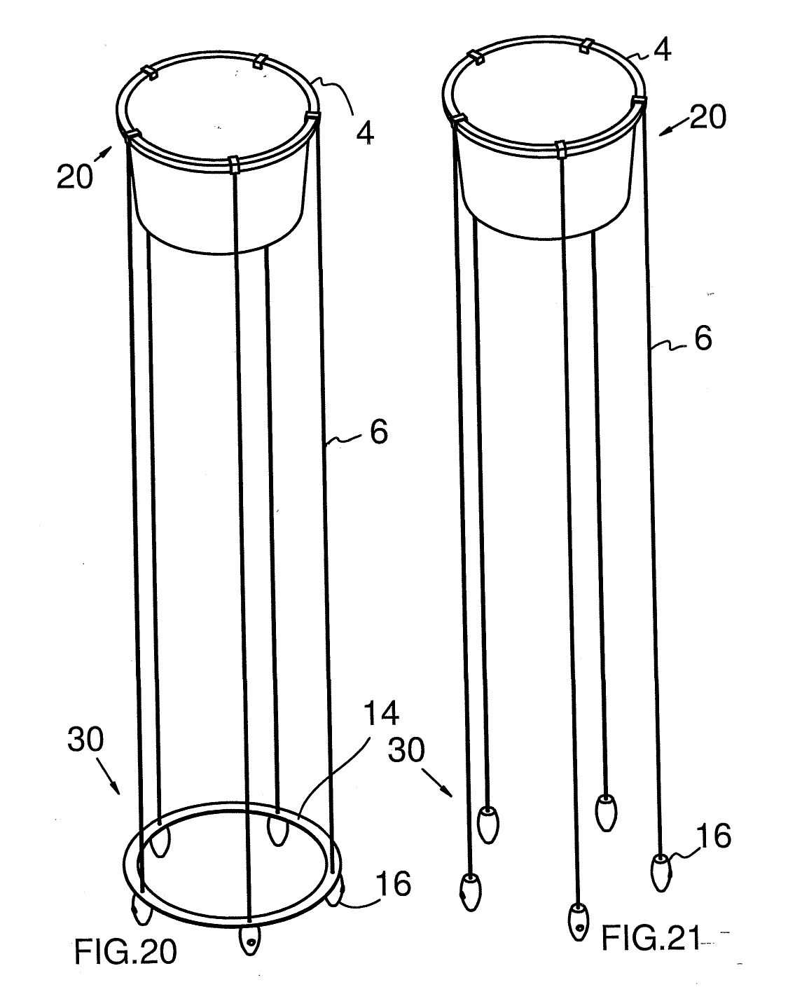

FIGS. 20 and 21 show two different versions wherein the support member 4 is in the form of a hanging basket. In this embodiment such elongate members 6 hang from the support member in circular arrangement. This embodiment also shows the spacing member 14 as a circular member. As with the previous embodiments such elongated members 6 may just have a weighted member 16 without a spacing bar or may have a spacing bar 14 to keep the vining plants in an orderly fashion.

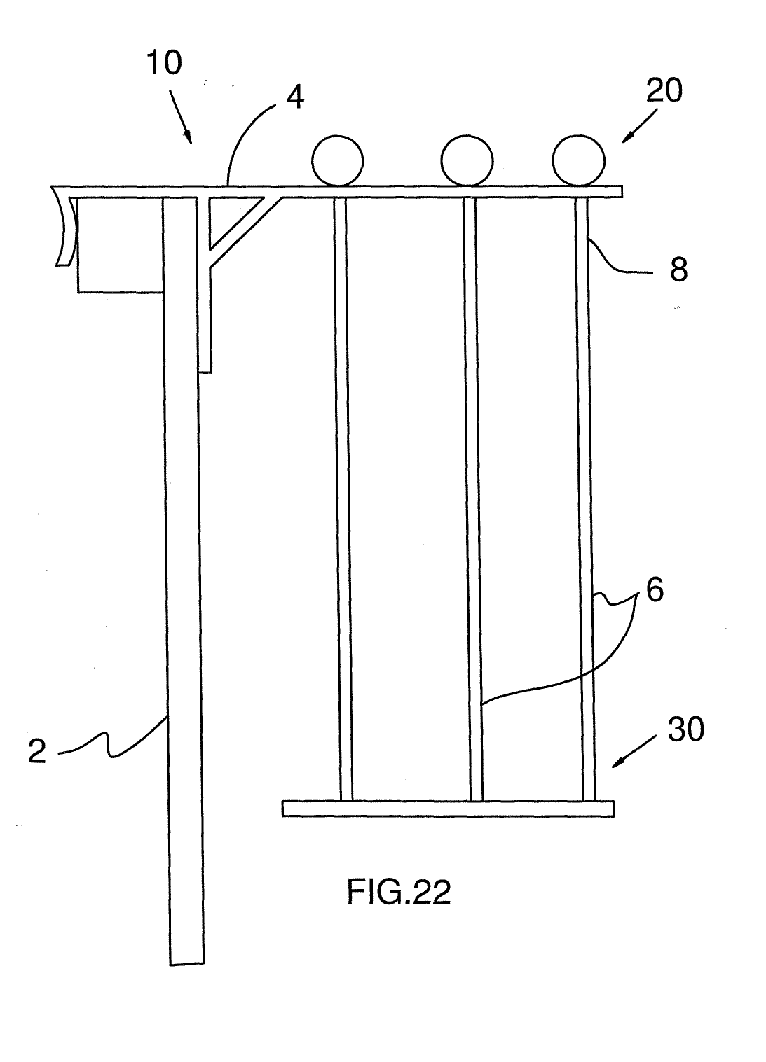

FIG. 22 shows again a different embodiment of the support member 4 wherein the support member 4 has an attachment formed therein for engagement with a deck rail or fence rail as the predetermined structure 2. This support member 4 is self supporting. In this embodiment such support member 4 merely fits over the predetermined member 2 and is firmly held in place without the need of any attachment means such as screws.

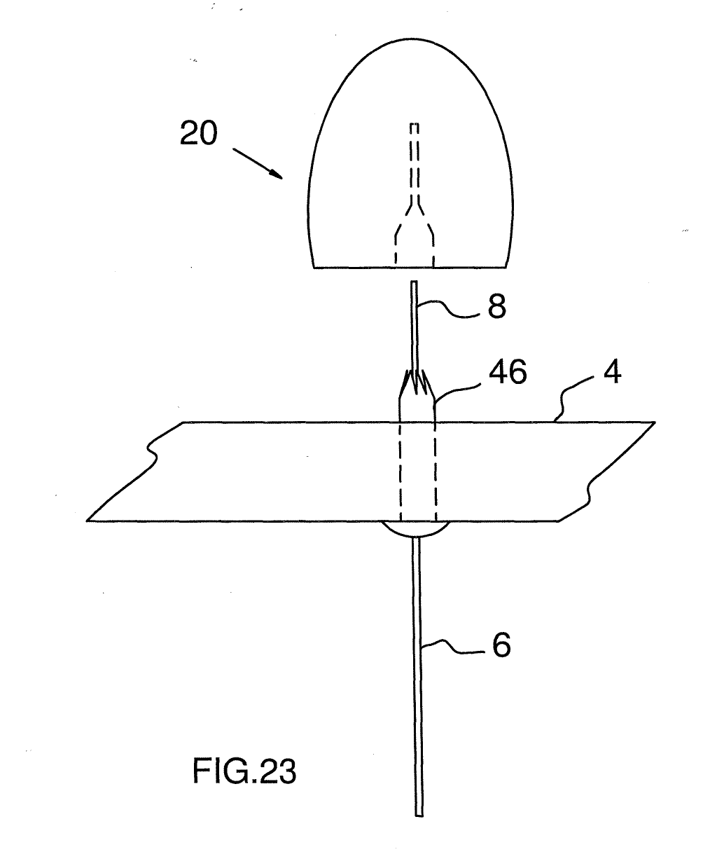

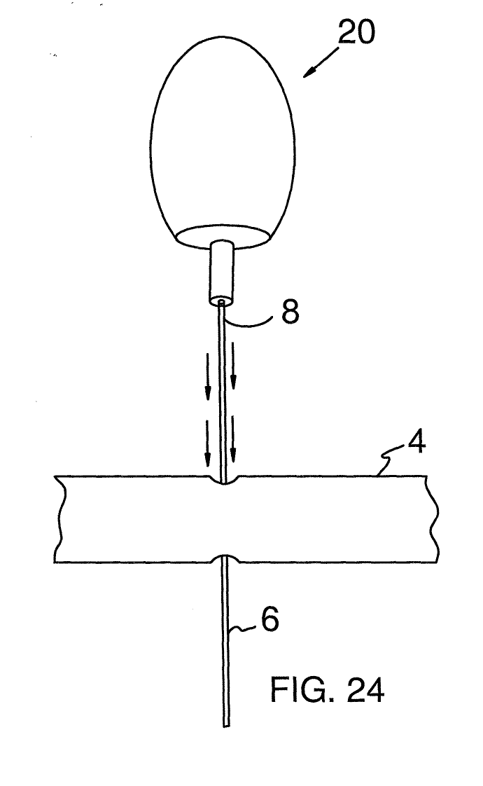

FIG. 23 shows a different means of securing such elongated member 6 to the support member 4. This embodiment shows an attachment where the elongated member 6 is held in place by a compression fit 46. FIG. 24 shows an arrangement wherein such first means 20 depicts yet another way of securing the elongated member 6 to the support member 4.

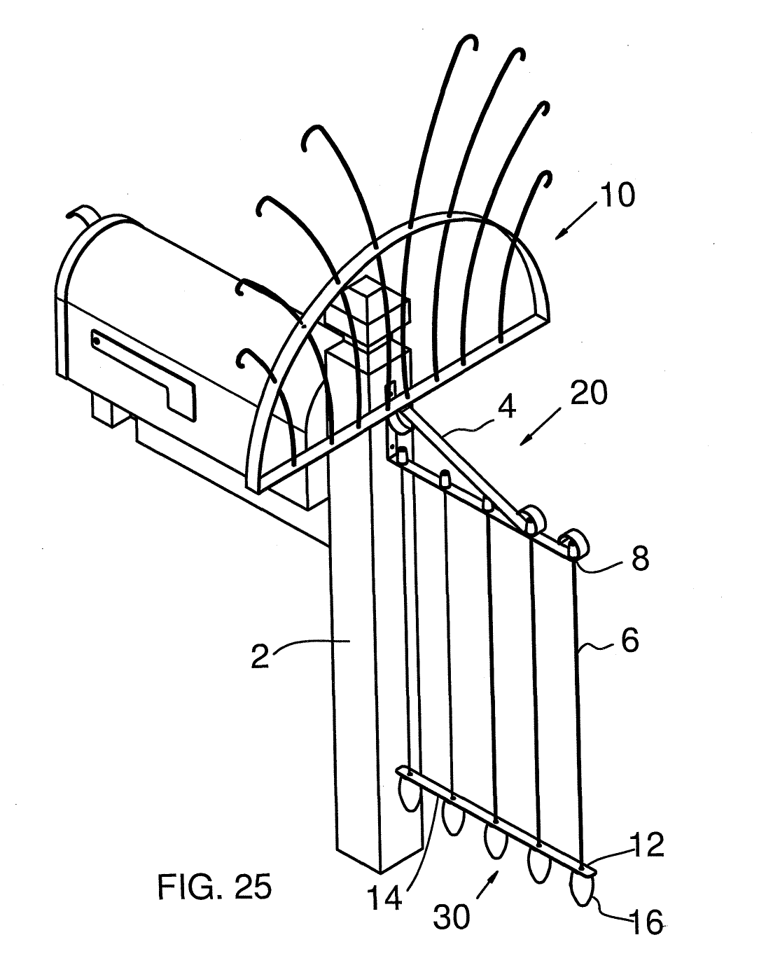

FIG. 25 shows a perspective view of an alternate embodiment of the invention wherein the support member of the apparatus is attached to a mailbox post and has a fan like mount above the support member 6 for having wining plants form a back drop for the mailbox.

It should be noted that FIG. 17 also shows a clip member 36 for securing the elongated member 6 to the support member 4. Further, FIG. 17 also shows such support member 4 that also includes a threaded mount 44 for mounting such apparatus 10 to a predetermined structure 2 such as a wall or post wherein the rest of the support member 4 threads into such wall mount 44.

In a second aspect the present invention provides an apparatus 10 for supporting a vine or a climbing plant. The apparatus 10 comprises a generally vertically disposed supporting structure, generally designated 50, extending above ground level for a predetermined distance and having each of a predetermined rigidity and a predetermined strength which are at least sufficient to support such vines and climbing plants. Such supporting structure 50 is engageable with and securable to a predetermined structure. Such predetermined structure can be a side of a building, a fence post, or virtually any vertically disposed structure. A support member 4 is engageable with and attached to the vertically disposed supporting structure 50, such support member 4 has a first predetermined shape, and each of a predetermined rigidity and a predetermined strength which are at least sufficient to support such vines and climbing plants. The support member 4 is disposed in one of a substantially horizontal plane, an arcuate plane or at a predetermined angular plane. There is at least one elongated member 6 having a predetermined length engageable with and suspended from such support member 4 for allowing such vines or climbing plants to intertwine therewith.

As seen in FIGS. 14A and 14B such supporting structure 50 can be a bracket 24 which mounts on the side of a predetermined structure 2 such as a building, a fence post, a wall or any other vertically disposed structure. Such bracket 24 permits adjustment so that such support member 4 can be raised or lowered depending upon the location and the desires of the user.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

1. An apparatus engageable with a predetermined structure for supporting vines and climbing plants, said apparatus comprising:
(a) at least one support member having a first predetermined shape, and each of a predetermined rigidity and a predetermined strength which are at least sufficient to support such vines and climbing plants, said support member engageable with and securable to such predetermined structure, said support member is generally one of linear and arcuate and is disposed in one of a substantially horizontal plane and at a predetermined angular plane, said support member having a plurality of generally vertically disposed apertures formed therein;
(b) a plurality of elongated members having a predetermined length engageable with and suspended through said apertures of said support member for allowing such vines and climbing plants to intertwine therewith; and
(c) at least one horizontal spacing member engaging said plurality of elongated members at a predetermined position for keeping a predetermined space between said plurality of elongated members.

2. The apparatus, according to claim 1, wherein said apparatus further includes a first means engageable with and adjacent a first end of said plurality of elongated members and said support member for retaining said plurality of elongated members in engagement with said support member.

3. The apparatus, according to claim 2, wherein said apparatus further includes a second means engageable with a second end of each of said plurality of elongated members for maintaining said plurality of elongated members in a substantially vertically disposed position.

4. The apparatus, according to claim 1, wherein said support member is formed of one of plastic, wood, metal and combinations thereof.

5. The apparatus, according to claim 1, wherein said plurality of elongated members is formed of one of wire, string, tubing, rods, wood, metal, twine, plastic, rope and combinations thereof.

6. (canceled)

7. The apparatus, according to claim 3, wherein said apparatus further includes at least one spacing member engaging said plurality of elongated members at a predetermined position for keeping a predetermined space between said plurality of elongated members.

8. The apparatus, according to claim 3, wherein said second means engageable with a second end of said plurality of elongated members includes a weighted member disposed on each of said second end thereof for keeping said plurality of elongated members in a vertical position.

9. The apparatus, according to claim 8, wherein said second means for retaining each of said plurality of elongated members separately in engagement with said weighted member includes at least one of a push nut, lock washer, adhesive, compression fit, knot, clip, cord lock, integral bottom member and threaded connection.

10. The apparatus, according to claim 2, wherein said first means for retaining said plurality of elongated members in engagement with said support member includes at least one of a push lock, lock washer, adhesive, compression fit, integral head member, knot, and clip.

11. The apparatus, according to claim 7, wherein said apparatus further includes a third means for securing said spacing member to a ground area so as to prevent such elongated members from moving in windy conditions.

12. The apparatus, according to claim 11, wherein said third means for securing said spacing member to such ground area includes a ground stake.

13. The apparatus, according to claim 1, including at least two support members having a connecting means for connecting ends of said at least two support members generally adjacent to such predetermined structure.

14. A apparatus for supporting vines and climbing plants, said apparatus comprising:
(a) a generally vertically disposed supporting structure extending above ground level for a predetermined distance and having each of a predetermined rigidity and a predetermined strength which are at least sufficient to support such vines and climbing plants said supporting structure engageable with and securable to a predetermined structure;
(b) a support member engageable with and attached to said vertically disposed supporting structure, said support member having a first predetermined shape, and each of a predetermined rigidity and a predetermined strength which are at least sufficient to support such vines and climbing plants, said support member generally one of linear and arcuate and is disposed in one of a substantially horizontal plane and at a predetermined angular plane, said support member having a plurality of generally vertically disposed apertures formed therein;
(c) a plurality of elongated members having a predetermined length engageable with and suspended through said apertures of said support member for allowing such vines and climbing plants to intertwine therewith; and
(d) at least one horizontal spacing member engaging said plurality of elongated members at a predetermined position for keeping a predetermined space between said plurality of elongated members.

15. The apparatus, according to claim 14, wherein said supporting structure includes a bracket generally adjacent to such predetermined structure.

16. The apparatus, according to claim 15, which includes a bracket adjusting means for adjusting a position of said support member on said bracket.

17. The apparatus, according to claim 14, wherein said apparatus further includes a first means engageable with and adjacent a first end of each of said elongated member and said support member for retaining said plurality of elongated members in engagement with said support member.

18. The apparatus, according to claim 17, wherein said apparatus further includes a second means engageable with a each second end of said elongated member for maintaining said plurality of elongated members in a substantially vertically disposed position.

19. (canceled)

20. (canceled)
